(19) United States
(12) Patent Application Publication
(10) Pub. No.: US 2010/0141552 A1
(43) Pub. Date: Jun. 10, 2010

(54) Methods and Systems for Imaging Device and Display Interaction

(76) Inventors: Andrew Rodney Ferlitsch, Camas, WA (US); Chang Yuan, Vancouver, WA (US)

Correspondence Address: Kristine Elizabeth Matthews, 19302 SE 31st Drive, Camas, WA, 98607, US

(21) Appl. No.: 12/328,010

(22) Filed: Dec. 4, 2008

(51) Int. Cl. G09G 5/00

(52) U.S. Cl. 345/1.3

(57) ABSTRACT

Aspects of the present invention are related to systems and methods for composite wall display and imaging device interaction.

### FIELD OF THE INVENTION

Embodiments of the present invention relate, in general, to display and imaging device interaction, and in particular, to composite wall display and imaging device interaction.

### SUMMARY

Some embodiments of the present invention comprise methods and systems for controlling a composite wall display communicatively coupled to an imaging device, wherein the composite wall display comprises a plurality of display panels. Some of these embodiments comprise a virtual wall display process comprising a script interpreter, a virtual-wall engine, a wall-display controller, an imaging-device controller and a virtual canvas associated with the plurality of display panels.

Some embodiments of the present invention comprise methods and systems for manipulation of a logical window in a composite wall display. Some of these embodiments comprise monitoring for a change associated with the logical window and an interaction with the logical window, updating a window priority associated with the logical window based on the results of the monitoring and adjusting the logical window based on the updated window priority.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture illustrating an exemplary composite wall display;

FIG. 2 is a picture illustrating an exemplary composite wall display comprising mullions;

FIG. 3 is a picture illustrating embodiments of the present invention comprising a composite wall display communicatively coupled with an imaging device and a computing system;

FIG. 4 is a picture illustrating an exemplary composite wall display and multiple logical windows;

FIG. 5 is a picture illustrating embodiments of the present invention comprising a virtual wall display process comprising a script interpreter, a virtual-wall engine, a wall-display controller and an imaging-device controller;

FIG. 6 is a picture illustrating an exemplary virtual canvas associated with a plurality of display panels;

FIG. 7 is a picture illustrating placement of an image on a region associated with a single display panel in an exemplary virtual canvas according to embodiments of the present invention, wherein the image may be scaled according to the size of the display panel;

FIG. 8 is a picture illustrating placement of an image in a logical window in an exemplary virtual canvas according to embodiments of the present invention, wherein the image may be scaled according to the size of the logical window;

FIG. 9 is a picture illustrating placement of an image on a region associated with a single display panel in an exemplary virtual canvas according to embodiments of the present invention, wherein the image may be sized according to its original size;

FIG. 10 is a picture illustrating adjustment of adjacent logical windows according to embodiments of the present invention when placing an image according to embodiments of the present invention;

FIG. 11 is a picture illustrating sending image content from one region in an exemplary virtual canvas to another region in the virtual canvas according to embodiments of the present invention;

FIG. 12 is a picture illustrating adjustment of adjacent logical windows according to embodiments of the present invention when sending image content from one region in an exemplary virtual canvas to another region in the virtual canvas according to embodiments of the present invention;

FIG. 13 is a chart showing embodiments of the present invention comprising monitoring for window changes, user interactions and user attention, updating window priorities and adjusting windows according to window priority;

FIG. 14 is a chart showing embodiments of the present invention comprising updating window priorities based on window change, user interaction and user attention;

FIG. 15 is a chart showing embodiments of the present invention comprising adjusting a logical window according to window priority; and

FIG. 16 is a picture illustrating window placement according to embodiments of the present invention.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Some embodiments of the present invention may comprise a display mosaic, also considered an overall display, a composite wall display and a display wall. In some of these embodiments of the present invention, a display mosaic may comprise multiple, separate displays which each, or in combination, may be considered a display panel, or tile. In some of these embodiments, the multiple, separate displays may be bolted together to form the composite display wall. In alternative embodiments of the present invention, a display mosaic may comprise a physically contiguous, single display, wherein different areas in the physically contiguous, single display may be considered display panels, or tiles. In some of the embodiments comprising a physically contiguous, single display, the display tiles may be non-overlapping. In other of the embodiments comprising a physically contiguous, single display, some, or all, of the display tiles may overlap.

In some embodiments of the present invention, the display tiles of a display mosaic may be located substantially proximate to each other. In alternative embodiments, the display tiles of a display mosaic may be located substantially distant from each other.

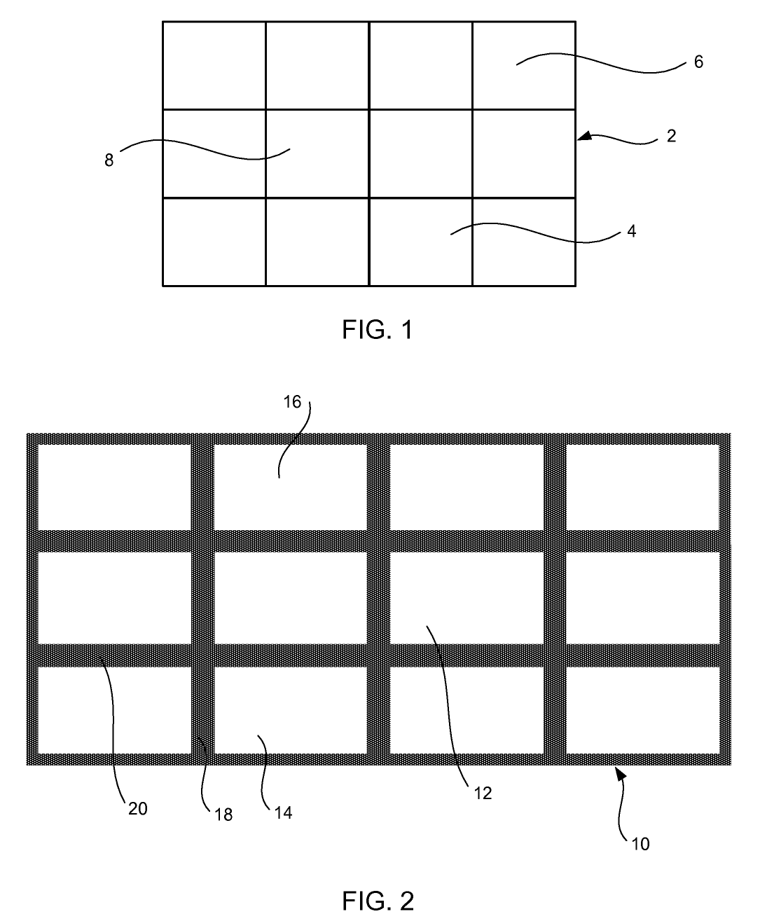

FIG. 1 depicts an exemplary display mosaic 2 comprising twelve, non-overlapping display tiles (three shown labeled 4, 6, 8). The exemplary display mosaic 2 may comprise twelve individual, separate displays wherein neighboring displays directly abut. Alternatively, the exemplary display mosaic 2 may comprise a single, physically-contiguous display 2 which may partitioned into multiple display tiles, wherein, in this example, the partition comprises twelve non-overlapping regions (three shown labeled 4, 6, 8).

FIG. 2 depicts a second exemplary display mosaic 10 comprising twelve, non-overlapping display tiles (three shown labeled 12, 14, 16). In this exemplary display mosaic 10, the display tiles do not abut, thereby creating a vertical 18 or horizontal 20 spacing between adjacent display tiles. This spacing 18, 20 between adjacent display tiles may be referred to as a mullion.

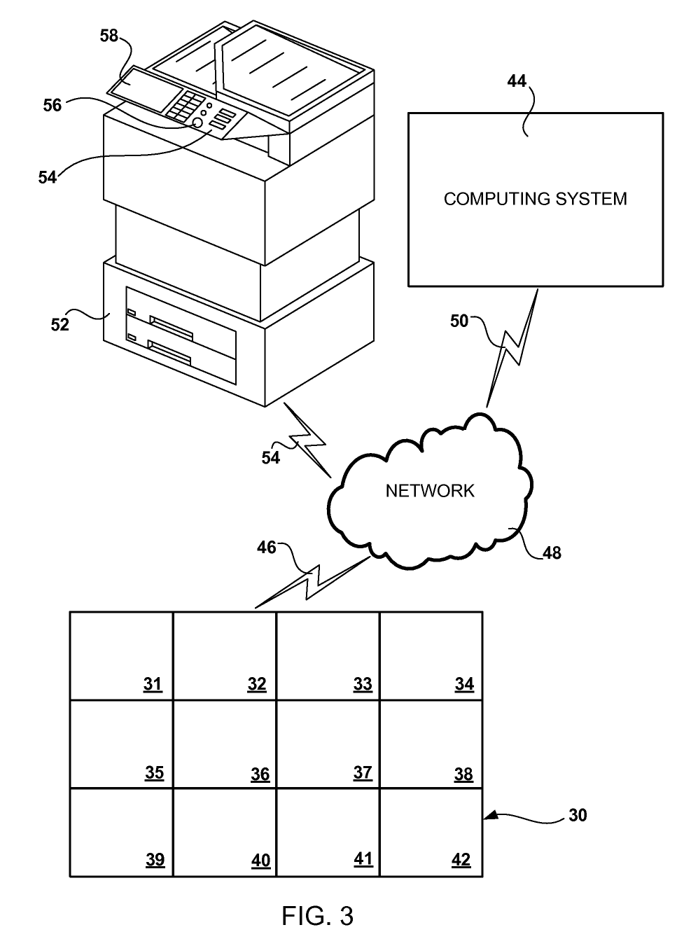

Exemplary display tiles may comprise an LCD (Liquid Crystal Display), an LED (Light Emitting Diode), an OLED (Organic Light-Emitting Diode) and other displays. Exemplary embodiments of the present invention may be described in relation to FIG. 3. These exemplary embodiments may comprise a composite wall display 30 comprising multiple display panels 31-42. The composite wall display 30 may be operated by a computing system 44. In some embodiments of the present invention, the computing system 44 may comprise a cluster of one or more computing devices. In one exemplary embodiment, the computing system 44 may comprise a number of computer nodes interconnected through one or more high-speed networks. Image data for display on the composite wall display 30 may be segmented into tiles and each tile may be sent to a different computer node. Each node may render the received image tile to the connected panels 31-42. In an alternative embodiment, the computing system 44 may comprise one or more computer nodes connected to one or more hardware boards, for example, an FPGA (Field-Programmable Gate Array). The hardware board may receive image pixels from one or more computer nodes and may route each pixel to the associated position on a display panel.

In some embodiments of the present invention, a display panel in a composite wall display may comprise a touch screen panel. In alternative embodiments of the present invention, a display panel in a composite wall display may be controlled by a gesture-based system. In a gesture-based system, an operator may interact with a display panel using body motions in free space. Body motions may comprise hand and/or arm motions. In yet alternative embodiments of the present invention, an operator may interact with a display panel in a composite wall display with a computer-human interface. Exemplary computer-human interfaces may include a keyboard, a mouse and a touch pad.

In exemplary embodiments of the present invention described in relation to FIG. 3, the composite wall display 30 may be communicatively coupled 46 with a network 48. The computing system 44 may be communicatively coupled 50 with the network 48 also. Exemplary networks include local area networks (LANs), wide area networks (WAN's), the Internet, cellular networks, satellite networks, wireless proximity networks (for example, Bluetooth, Wi-Fi, WiMAX and other wireless proximity networks) and other networks. One or more imaging devices 52 may be communicatively 54 coupled to the network 48.

In some embodiments, the imaging device 52 may take the form of a multi-function peripheral device (MFP) that may combine the functions of two or more traditionally separated imaging devices. An MFP may combine any number of imaging devices, but typically comprises the functions of one or more of the following exemplary imaging devices: a printer, a scanner, a copier, a filing device, a document management device, a publishing device, a media duplication device, a display device and a fax machine. In alternate embodiments, the imaging device 52 may take the form of a single-function imaging device. Exemplary single-function imaging devices comprise a printer, a scanner, a copier, a filing device, a document management device, a publishing device, a media duplication device, a display device, an A/V (Audio/Video) recorder/player and a fax machine.

Communication and transport of data between the imaging device 52 and the computing system 44 may be by any protocol or combination of protocols, of which exemplary protocols may comprise WS/SOAP (Web Services/Simple Object Access Protocol), SOAP/XML (Simple Object Access Protocol/eXtensible Markup Language), DIME (Direct Internet Message Encapsulation), FTP (File Transfer Protocol), NFS (Network File System), SMTP (Simple Mail Transfer Protocol), HTTP/HTML (HyperText Transfer Protocol/HyperText Markup Language), Email, a proprietary protocol over TCP/IP (Transmission Control Protocol/Internet Protocol) and AppleTalk®.

Communication and transport of data between the imaging device 52 and the composite wall display 30 may be by any protocol or combination of protocols, of which exemplary protocols may comprise WS/SOAP, SOAP/XML, DIME, FTP, NFS, SMTP, HTTP/HTML, Email, a proprietary protocol over TCP/IP and AppleTalk®.

Communication and transport of data between the computing system 44 and the composite wall display 30 may be by any protocol or combination of protocols, of which exemplary protocols may comprise WS/SOAP, SOAP/XML, DIME, FTP, NFS, SMTP, HTTP/HTML, Email, a proprietary protocol over TCP/IP and AppleTalk®.

The imaging device 52 may comprise a user interface (UI) panel 54, which may comprise input buttons 56 and a display device 58. In some embodiments, the display device 58 may comprise a touch panel system with or without input buttons. In other embodiments, the display device 58 may be operated remotely from the imaging device 52. In some of these embodiments, the display device 58 may be operated at the imaging device 52 using a web browser which may operate an embedded web page in the display device 58.

In some exemplary embodiments of the present invention, an imaging device may be communicatively coupled with removable or external storage via a hostless or hosted connection. Exemplary removable or external storage systems may comprise a USB (Universal Serial Bus) thumb drive, a memory stick reader, a CD-ROM/DVD (Compact Disk-Read Only Memory/Digital Versatile Disc) drive, a floppy disk drive, a cellular telephone, a PDA (Personal Digital Assistant), an FTP site, an HTTP site and network (or otherwise remote) mounted file system or storage (for example, NFS (Network File System)). The connection between the imaging device and the removable or external storage may be any communications link, such as a network connection, a telephone line, a serial cable, an IrDA (Infrared Data Association) link, an optical network connection, or some other wired or wireless communications link. Communication and transport of data between the imaging device and the removable or external storage may be by any protocol or combination of protocols, of which exemplary protocols may comprise WS/SOAP, SOAP/XML, DIME, FTP, NFS, SMTP, HTTP/HTML, a proprietary protocol over TCP/IP and AppleTalk®. In some embodiments, the imaging device may comprise an integral coupling mechanism for accessing removable or external storage. Exemplary integral coupling mechanisms may comprise a USB port, a parallel port, a serial port, a memory stick reader, a CD/DVD drive, a floppy disk drive and a proximity reader.

In some embodiments, a display device on an imaging device may be under the control of an external application, which may be hosted on a remote computing device, a remote server or another computing host. In some embodiments, the external application may control the display device via web services. In some embodiments, the external application may be hosted within the imaging device, and the external application may run as a guest application. Some of these embodiments may comprise Java VM. Alternative of these embodiments may comprise VMWare.

In some embodiments, an imaging device may be under the control of an external application, which may be hosted on a remote computing device, a remote server, or another computing host. In some embodiments, the external application may control the imaging device via web services. In some embodiments, the external application may be hosted within the imaging device, and the external application may run as a guest application. Some of these embodiments may comprise Java VM. Alternative of these embodiments may comprise VMWare.

In some embodiments, one or more imaging device controlling applications may be stored on a data store that is communicatively coupled to one or more remote computing devices and/or one or more remote servers. In some embodiments, a data store may be communicatively coupled with the imaging device. In some embodiments, the data store may be internally hosted. Exemplary internally hosted data stores include hard disks, flash storage and other internal data stores. In alternative embodiments, the data store may be externally hosted, for example through a data-store service. In still alternative embodiments, the data store may comprise removable storage. In still alternative embodiments, the data store may be hosted external to the local network, for example, stored in a cloud computing data storage service. An exemplary cloud computing data storage service is an Amazon Elastic Compute Cloud (Amazon EC2).

The connection between a data store and a remote computing device may be any communications link, such as a network connection, a telephone line (PSTN), a serial cable, an IrDA link, an optical link, or some other wired or wireless communications link. Communication and transport of data between the data store and the remote computing device may be by any protocol or combination of protocols, of which exemplary protocols may comprise WS/SOAP, SOAP/XML, DIME, FTP, NFS, SMTP, HTTP/HTML, Email, a proprietary protocol over TCP/IP and AppleTalk®.

The connection between a data store and a remote server may be any communications link, such as a network connection, a telephone line, a serial cable, an IrDA link, an optical link, or some other wired or wireless communications link. Communication and transport of data between the data store and the remote server may be by any protocol or combination of protocols, of which exemplary protocols may comprise WS/SOAP, SOAP/XML, DIME, FTP, NFS, SMTP, HTTP/HTML, Email, a proprietary protocol over TCP/IP and AppleTalk®.

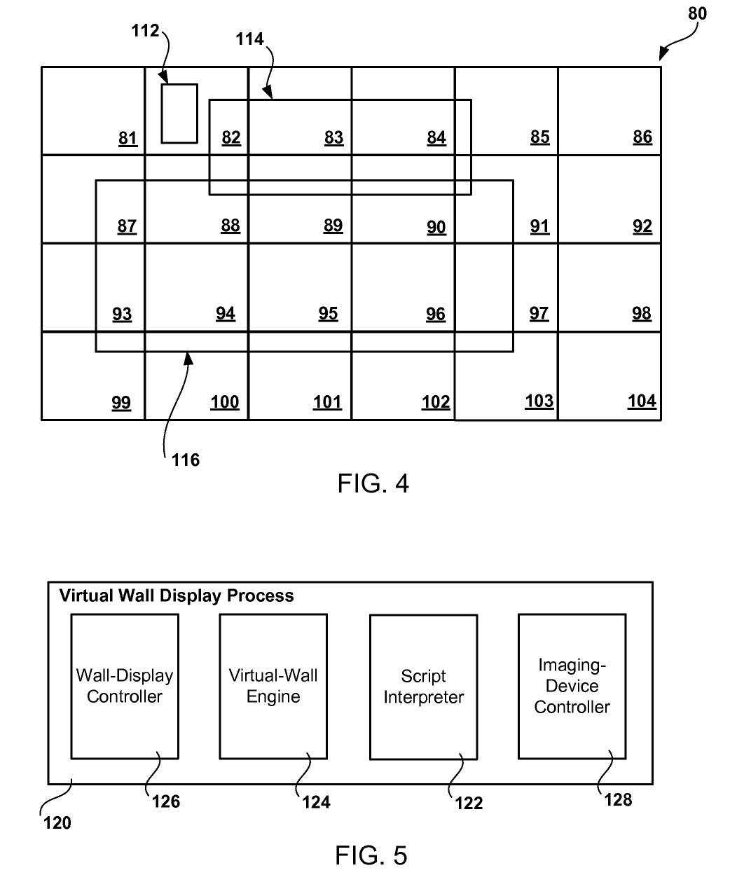

Some embodiments of the present invention may be described in relation to an exemplary configuration depicted in FIG. 4. A composite wall display may comprise multiple panels. All of the pixels from the physical panels in a composite wall display may be grouped into a virtual canvas 80 comprising multiple regions 81-104, each of which may be associated with a physical panel. The virtual canvas 80 may also be referred to as the virtual wall display. A logical window 112, 114, 116 may be defined as a portion of the virtual canvas 80. An exemplary logical window 112 may be associated with a portion of one physical panel 82. Another exemplary logical window 114 may be associated with a portion of more than one physical panel 82, 83, 84, 85, 88, 89, 90, 91. Another exemplary logical window 116 may be associated with a portion of more than one physical panel 87, 88, 89, 90, 91, 93, 97, 99, 100, 101, 102, 103 and all of other physical panels 94, 95, 96. Other exemplary logical windows (not labeled) may be associated with all of one or more physical panels. One or more logical windows may concurrently reside within a virtual canvas 80. One or more logical windows 114, 116 may overlap. Logical windows may be any shape, for example, rectangular, square, elliptical, circular, arbitrary-area shape and other shapes. In some embodiments of the present invention, the size, shape and position of a logical window may be arbitrarily changed. The parameters for a physical panel may be fixed.

A source of information content may be associated with a logical window for display. When the logical window associated with an information-content source is moved, scaled or otherwise changed, the content may be rendered adaptive to the changed, logical window. The wall display system may convert the rendered window to the physical panels and determine the color values for all of the pixels across the display.

In some embodiments of the present invention, each logical window may be associated with a set of parameters. Exemplary parameters associated with a logical window may comprise shape parameters, position parameters, size parameters, z-order parameters and other window parameters. In some embodiments of the present invention, a logical window with smaller z-order may be overlapped by a logical window with a larger z-order if the two logical windows intersect spatially. In some embodiments of the present invention, the intersection, abutment or overlap between multiple logical windows may be dynamically changed based on an observer's viewing position. In some embodiments, a viewing position may be characterized by the angle and/or distance between the observer and the display.

Some embodiments of the present invention described in relation to FIG. 5 may comprise a virtual wall display process 120 which may be executed on a computing device within the computing system. In some embodiments of the present invention, the virtual wall display process 120 may be related to an open API (Application Program Interface). In some embodiments of the present invention, the open API may be referred to as an Open Wall API. The virtual wall display process 120 may comprise a script interpreter 122 which may provide a human/program interface, a virtual-wall engine 124 which may comprise wall display and imaging device emulation, a wall-display controller 126 and an imaging-device controller 128.

In some embodiments of the present invention, an operator may interactively or programmatically operate the wall display and integrated imaging device using a set of commands to manipulate the virtual canvas. The virtual-wall engine 124 may emulate the operation of the display wall and the imaging device. The virtual-wall engine 124 may automatically adapt the virtual canvas to localized changes. The adaptations may maintain the content, aspect ratio and relative position of the entire virtual display surface. The wall-display controller 126 and the imaging-device controller 128 may translate the state of the virtual wall display to commands for operating the physical wall display and the imaging device.

Some embodiments of the present invention may comprise a set of commands which may manipulate a virtual canvas.

Some embodiments of the present invention may comprise a VIEW command that may be used to display an image on a virtual wall display. According to VIEW command parameters, an image may be associated with either a physical panel or a logical window. According to VIEW command parameters, an image may be scaled to fit a physical panel, to fit a logical window or to preserve the original scale of the image. When a VIEW command is issued, the physical panel or logical window associated with the viewable area of the image may be tagged with an image identifier that identifies the image. Some modes of the VIEW command may be described in relation to FIG. 6. FIG. 6 depicts an exemplary virtual wall display 140 associated with a physical wall display comprising twenty-four non-overlapping display tiles each associated with a region of the virtual wall display 141-164.

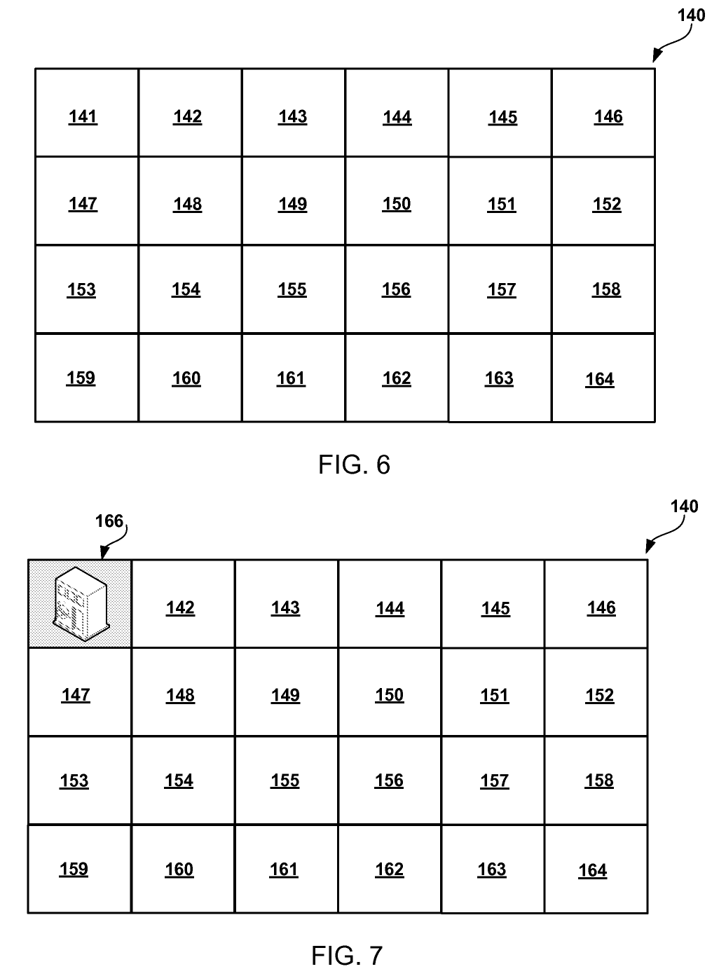

In an exemplary mode of some embodiments of the present invention described in relation to FIG. 6 and FIG. 7, an image may be displayed to a portion of the virtual wall display 140 associated with a physical panel 141. In some embodiments, the default may be to scale the image fit into the entirety of the physical panel 141, thereby creating a logical window 166 with a size and position identically associated with those of the physical panel 141. In this exemplary mode, the content of the physical panel 141 in the virtual wall display 140 may be replaced with the new image data. All remaining areas of the virtual wall display 140 may be unaffected. An exemplary command according to this mode may be view($image1, p1), where the command may effectuate the copy of image $image1 to panel number 1, where panel number 1 may be the first panel in a panel-numbering scheme starting with 1 in the upper-left corner.

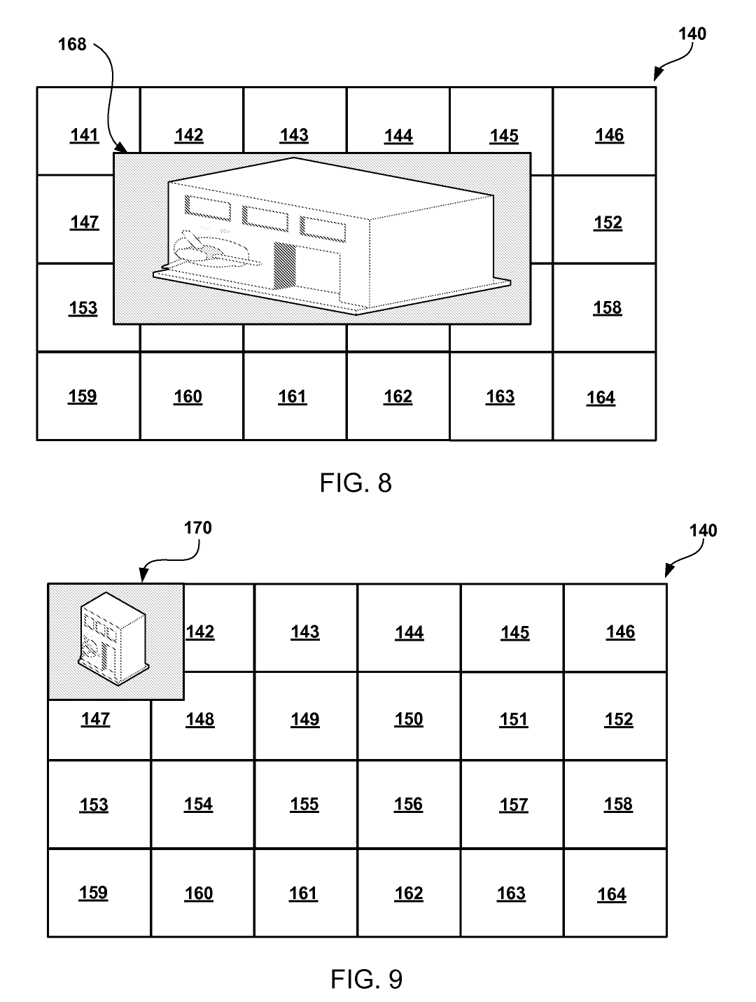

In an exemplary mode of some embodiments of the present invention described in relation to FIG. 6 and FIG. 8, an image may be displayed to a portion of the virtual wall display 140 associated with a pre-existing logical window 168. In some embodiments, the default may be to scale the image fit into the entirety of the logical window 168 which may span a region associated with one or more physical panels 141-145, 147-151, 153-157. In this exemplary mode, the content of the logical window 168 in the virtual wall display 140 may be replaced with the new image data. All remaining areas of the virtual wall display 140 may be unaffected. An exemplary command according to this mode may be view($image1, w2), where the command may effectuate the copy of image $image1 to the logical window identified by w2.

In an exemplary mode of some embodiments of the present invention described in relation to FIG. 6 and FIG. 9, an image may be displayed to a portion of the virtual wall display 140 associated with a physical panel 141. In this exemplary mode, the image may be displayed according to its true scale. The image may occupy a region of an area more or less than the region associated with the physical panel 141, depending on the image size. In these embodiments, a logical window 170 with a size corresponding to the image size and position anchored to the origins of the physical panel 141 may be created. An exemplary command according to this mode may be view($image1, p1, scale), where the command may effectuate the true-scale copy of image $image1 anchored to panel number 1, where panel number 1 is the first panel in a panel-numbering scheme starting with 1 in the upper-left corner. The display system may determine the color values for all pixels within the logical window.

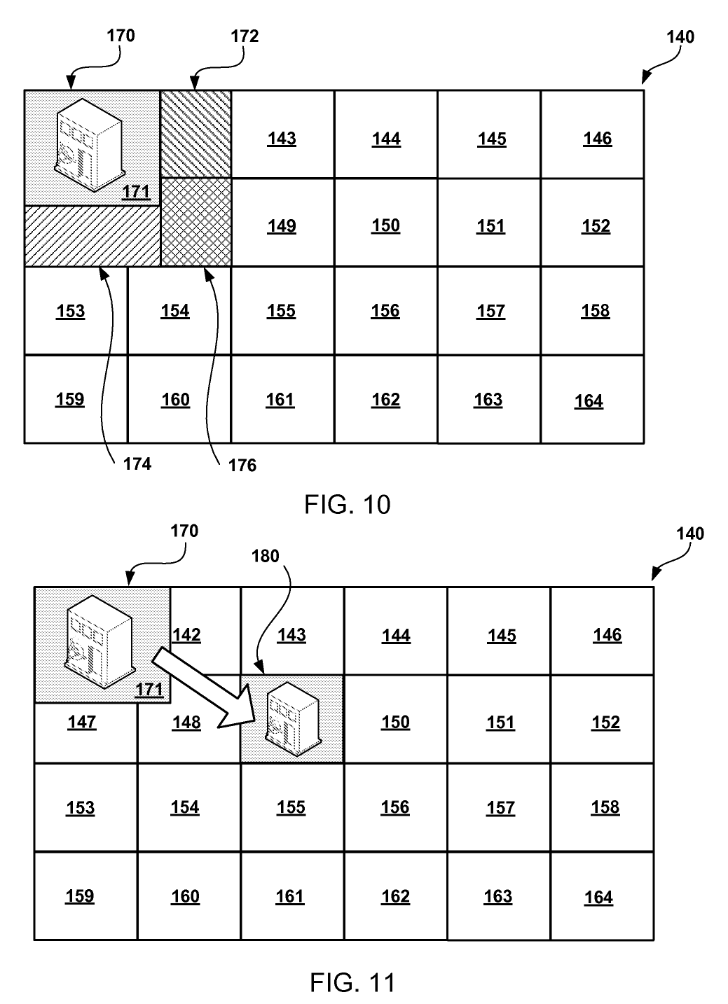

When the true-scale image is not contained entirely within the region associated with the physical panel indicated within the VIEW command, the virtual wall engine may automatically adjust any adjacent logical windows. This process may be described in relation to an example depicted in FIG. 6, FIG. 9 and FIG. 10. In some embodiments of the present invention, the virtual wall engine may create a logical window 170 scaled to the dimensions of the image 171. The logical window may be anchored at the origin associated with the physical panel. The display system may determine the color values for all of the pixels within the logical window.

In the example depicted in FIG. 9 and FIG. 10, the logical window 170 may cover all of a first panel (141 as shown in FIG. 6) and portions, but not the entirety, of the three adjacent panels (142, 147, 148 shown in FIG. 6). The virtual wall engine may automatically adjust any adjacent logical windows. In one condition, an adjacent panel may correspond to an adjacent logical window. In some embodiments of the present invention, the adjacent logical window may be replaced by a logical window corresponding to the remaining adjacent panel space after placement of the image 170. This condition may be illustrated in relation to FIG. 10.

A first logical window 170 may be formed according to the size of the image 171. A second logical window 172 may be formed from the remaining portion of the adjacent panel 142, and the content previously displayed in the entirety of this panel may be down-scaled to fit in this remaining portion of the panel, now associated with a second logical window 172. A third logical window 174 and a fourth logical window 176 may be formed and associated with the logical windows associated with the adjacent panels 147, 148, respectively. The previously displayed content of each of these adjacent panels 147, 148 may be appropriately scaled and displayed and associated with the newly formed logical windows. In some embodiments of the present invention, any uncovered panel area may be set to a default background value. In some embodiments, the default background value may be a value corresponding to a blank value.

Some embodiments of the present invention may comprise a PRINT command that may be used to print an image from a virtual wall display. In some embodiments of the present invention, when a PRINT command is issued to print an image, the virtual wall engine may look-up and may locate either the physical panel or logical window associated with the displayed image. The content of the physical panel or logical window may be printed.

In some embodiments of the present invention, a default print mode may be to scale the image to a predetermined ratio of logical window area to paper. In one exemplary embodiment, the default may associate the area of a physical panel with a letter-size paper in landscape orientation. Thus if an image is displayed in a single physical panel, then the image may be printed on a letter-size paper in landscape mode. If the image is displayed in a logical window wherein the logical window is less in size than a physical panel, then the image may be printed in a proportionally reduced area of the letter-sized paper. If the area of the image exceeds the area of a physical panel, then the image may be printed across several sheets of letter-sized paper. This may be referred to as poster printing. An exemplary command according to this mode may be print($image1), where the command may effectuate the printing of image1 according to a default ratio of panel-to-paper size.

In an exemplary mode of some embodiments of the present invention, an image may be printed to the scale of a physical panel. In this exemplary print mode, an image may be printed on a paper of a paper size associated with a physical panel. In some embodiments, a physical panel may be associated with letter-sized paper. If the image is associated with a physical panel, the image may be scaled to fit the paper according to the default panel-to-paper ratio. If the image is associated with a logical window, then the image may be scaled according to the proportion of the logical window to the physical panel, and then scaled to the default panel-to-paper ratio. An exemplary command according to this mode may be print($image1, fit-to-panel), where the command may effectuate the printing of image1 proportioned to a panel-to-paper ratio.

In an exemplary mode of some embodiments of the present invention, a print request may comprise a request to print the contents associated with a physical panel. If a single image is displayed in the panel, then the image may be scaled according to the default panel-to-paper ratio. If the request is to print a panel while preserving the original image scale, then the virtual wall engine may temporarily create a logical window that is in proportion to the original scale of the image associated with the physical panel. The image may be scaled according to the proportion of the logical window to the physical panel, and then scaled to the default panel-to-paper ratio. If a physical panel is displaying multiple images, then the virtual wall engine may temporarily create a logical window associated with the portions of the images displayed in the physical panel and scale the content of this logical window appropriately. Exemplary commands according to this mode may be print(p1) and print(p1, scale), where the commands may effectuate the printing of panel p1 with a default scale and a scale associated with the original image scale, respectively.

In an exemplary mode of some embodiments of the present invention, a print request may comprise a request to print the contents associated with a physical panel. In some embodiments of the present invention, the default associated with this mode may be to print the image contents of the logical window according to the window-to-panel ratio which may then be scaled to the panel-to-paper ratio. In some embodiments, if a logical window spans across multiple physical panels, then the content of each panel may be printed on a paper of the paper size associated with a physical panel. In alternative embodiments, logical-window content which spans two consecutive physical panels, wherein a physical panel is associated with letter-size paper, may be printed on ledger paper, if available. An exemplary command according to this mode may be print(w1), where the command may effectuate the printing of the content of logical window w1.

Alternatively, a print command comprising a request to print a logical window may further comprise a fit-to-panel selection. The virtual wall engine may create a temporary logical window with the size of a physical panel. The virtual wall engine may scale the image from the original logical window size to the panel size. The image content of the temporary logical window may be printed according to the panel-to-paper size setting. An exemplary command according to this mode may be print(w1, fit-to-panel), where the command may effectuate the printing of the content of logical window w1 according to panel-size scaling.

Some embodiments of the present invention may comprise a SCAN command that may be used to scan an image from an imaging device to a virtual wall display.

In a first mode, an image may be scanned to a physical panel and may be scaled to fit the physical panel. An exemplary command according to this mode may be $image1=scan(p1, fit-to-panel), where the command may effectuate the scanning from an imaging device to a physical panel p1 an image which may be tagged image 1. The image may be displayed scaled to fit within the physical panel.

In a second mode, a scanned image may be scaled to its original size. In this mode, the virtual wall engine may create a logical window according to the size of the scanned image, and the logical window may be anchored to the origins of a specified physical panel. Adjacent panels may be automatically adjusted. An exemplary command according to this mode may be $image1=scan(p1, scale), where the command may effectuate the scanning from an imaging device to a logical window anchored at physical panel p1 an image which may tagged image1. The image may be displayed scaled to the original image size.

In a third mode, a scanned image may be scanned to a logical window associated with a physical panel. In some of these embodiments, the image in the widow associated with the panel may be replaced with the scanned image, and the scanned image may be scaled according to the size of the logical window. An exemplary command according to this mode may be $image1=scan(p1), where the command may effectuate the scanning from an imaging device to a logical window anchored at physical panel p1 an image which may tagged image1. The image may be displayed scaled to the size of the logical window.

Some embodiments of the present invention may comprise a SEND command that may be used to copy an image from a first physical panel or a first logical window to another location. Exemplary locations may include a second physical panel, a second logical window, a network address, another virtual wall display and other locations.

In a basic mode of some embodiments of the present invention, a send command may effectuate the copying of the content of a first panel to a second panel. No changes may occur to the first panel. An exemplary command according to this mode may be send(p1, p9, no-change), where the command may copy the content of panel p1 to panel p9 with no scale change.

In an alternative panel-to-panel mode described in relation to FIG. 6 and FIG. 11, a logical window 170 may be associated with a first panel 141. The image contained in the logical window 170 associated with the first panel 141 may be copied to a second panel 149 creating a second logical window 180. The image 171 contained in the first logical window 170 associated with the first panel 141 may be scaled to fit the size of the physical panel. No changes may occur to the first panel 141 logical window 170. An exemplary command according to this mode may be send(p1, p9, fit-to-panel), where the command may copy the content of panel p1 to panel p9 with a scale change to fit the image within a physical panel.

In an alternative mode of some embodiments of the present invention, an image may be copied from a physical panel to a logical window associated with a physical panel. The virtual wall engine may create a temporary logical window scaled to the destination window. The virtual wall engine may scale the image from the first panel to the size of the temporary window and may place the scaled image in the temporary window. The image from the temporary window may be copied to the destination window. No changes may occur to the content of the adjacent panels at the destination window.

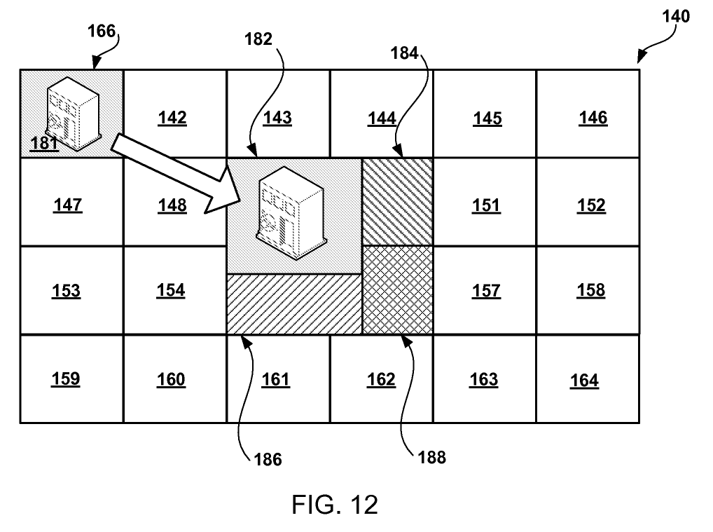

In an alternative mode of some embodiments of the present invention described in relation to FIG. 6 and FIG. 12, a scaled image 181 may be copied from a panel 141 or a logical window 166 to a destination panel 149 wherein the image 181 may be scaled according to its original size. An original image, for example, may have been greater in area than one panel, but the original image may have been scaled down to fit in the first panel. When copying the image from the first panel to a second panel, the virtual wall engine may create a logical window 182 associated with the destination panel 149 wherein the size of the logical window is the size of the original image. The original image may be copied to the new window associated with the destination panel. The panels adjacent 150, 155, 156 to the destination panel 149 to which the logical window 182 may be anchored may be adjusted 184, 186, 188 to preserve content and aspect ratio. An exemplary command according to this mode may be send(p1, p9, scale), where the command may copy the content of panel p1 to panel p9 with a scale change to the size of the original image.

Some embodiments of the present invention comprise methods and systems for automatic logical-window management. Some of these embodiments may comprise a window-management module. The window-management module may track parameters associated with all logical windows. The window-management module may also arrange logical windows for convenient viewing of the information content associated with a logical window. The window-management module may provide efficient and convenient utilization of the large real estate of the virtual canvas.

In some embodiments of the present invention, a priority measure may be assigned to each logical window. In some embodiments, the priority measure may be an integer greater than zero. The priority measure associated with a logical window, also considered a window priority, may be used, in some embodiments of the present invention, to control how a logical window may be displayed on the composite wall display. In some embodiments of the present invention, a larger window priority may be associated with a greater importance of the associated window to a user or viewer than a window with a lower window priority. In some embodiments of the present invention, a window-management module may manage logical windows based on window priorities.

In some embodiments of the present invention, a first logical window with a higher window priority may be placed closer to the center of the virtual canvas than a second logical window with a lower window priority.

In some embodiments of the present invention, the size of a first logical window with higher window priority may be larger than a second logical window with a lower window priority.

In some embodiments of the present invention, a first logical window with a higher window priority may not be overlapped by a second logical window with a lower window priority.

In some embodiments of the present invention, a newly created logical window may be assigned a high window priority.

In some embodiments of the present invention, a window priority associated with a logical window which has received recent user interaction may increase. Exemplary user interaction may comprise mouse clicking, dragging and other user interaction. In some embodiments of the present invention, a window priority associated with a logical window which is being viewed by an observer may increase. In some embodiments, the observer's view location may be determined using an eye tracking system.

In some embodiments of the present invention, a window priority associated with a logical window may decrease gradually when the logical window does not receive user interaction or user attention for a specified period of time.

In some embodiments of the present invention, a user may assign a window priority.

In some embodiments of the present invention, a window priority associated with a logical window which has received recent user attention may increase. Exemplary user attention indicators may comprise eye tracking indicating a user is viewing a logical window, gesture tracking indicating a user is pointing to or gesturing toward a logical window and other user attention indications.

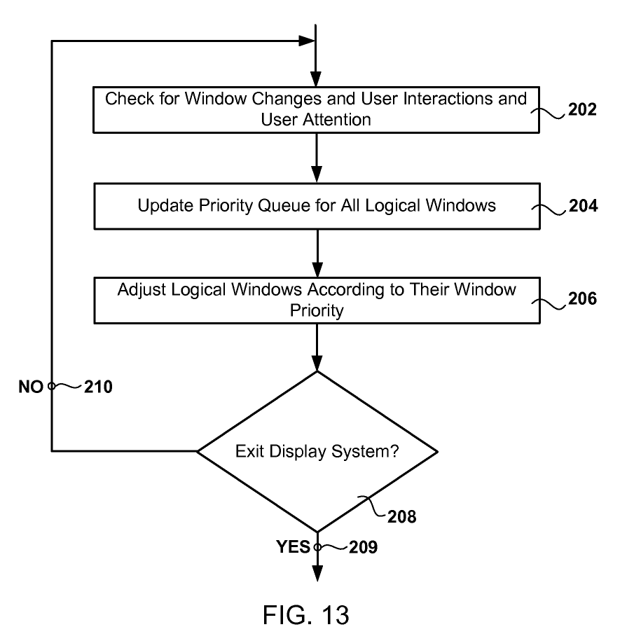

Some embodiments of the present invention may comprise adjustment of window size and position according to any, or all, of the above-listed criteria. In some embodiments of the present invention, all logical windows may be sorted by window priority and maintained in a sorted list. Some embodiments of the present invention may be described in relation to FIG. 13. In these embodiments, a window-management module may query for window changes, user interactions, and user attention 202. Exemplary window changes may include window creation, window resizing due to content change, window moving due to content change and other window changes. Exemplary user interactions may include a mouse click, a dragging operation, data entry through a keyboard and other user interactions. Exemplary user attention indicators may comprise eye tracking indicating a user is viewing a logical window, gesture tracking indicating a user is pointing to or gesturing toward a logical window and other user attention indications. All window priorities may be updated 204. If there are any window changes or user interactions or user attention, then the window priority for the affected windows may be updated. The window priority for an unaffected window may be updated based on the time duration between the window creation time and the current time. The display system may reposition and resize a logical window 206 based on the updated priorities. This process may continue 210 until a signal to exit the display system 208 may be received 209.

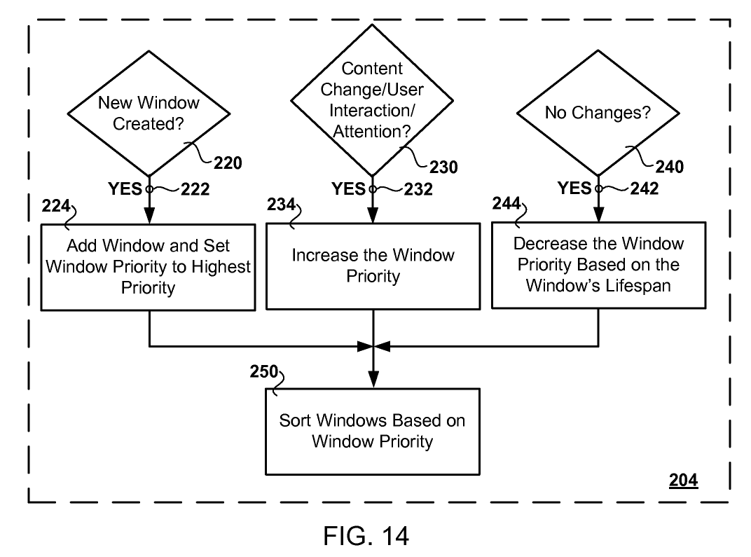

In some embodiments of the present invention, updating the priority queue for all logical windows 204 may be described in relation to FIG. 14. In these embodiments, a window may be examined 220, and if a window is newly created 222, then the window may be added to the window queue and the newly added window's window priority may be set to the highest priority 224. In some embodiments, the highest priority may be the absolute highest priority. In alternative embodiments, the highest priority may be the priority value greater than the current highest priority in the queue. A window may be examined 230, and if the window content has changed or a user has interacted with the window or user attention has been directed to the window 232, then the window priority associated with the affected window may be increased 234. A window may be examined 240, and if not changes have occurred 242, then the window priority associated with the examined window may be decreased 244 according to the lifespan of the window. After each window priority has been updated, the window list may be sorted 250 based on window priority. In some embodiments of the present invention, the window queue may be maintained in descending order of window priority. In alternative embodiments, the queue may be maintained in a different order.

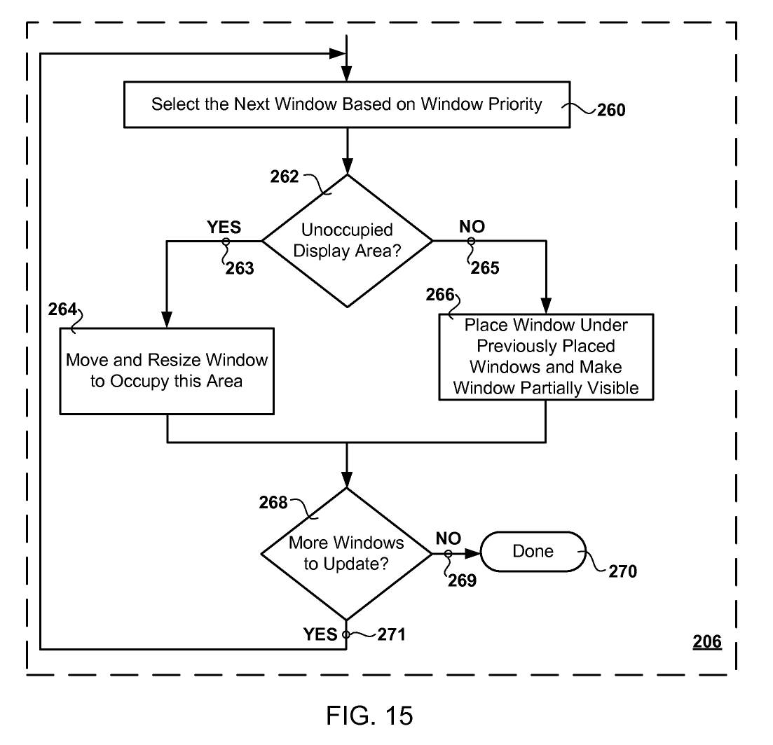

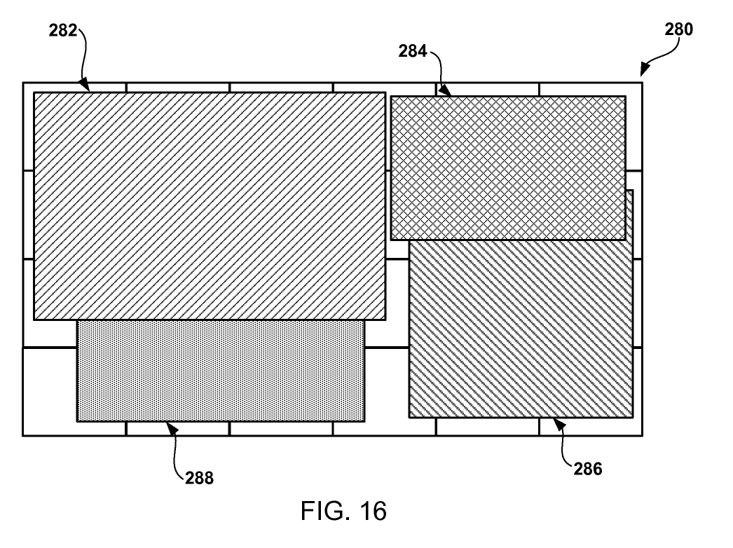

In some embodiments of the present invention, adjusting 206 the logical windows according to their window priority may be described in relation to FIG. 15. In these embodiments, the next window for adjustment may be selected 260 based on window priority. The display area may be examined 262 to determine if there are unoccupied display regions sufficiently large to accommodate the current window. If there are 263 large enough unoccupied display regions, then the window currently being adjusted may be resized to occupy the area and moved to the area 264. If there are no 265 unoccupied display regions of sufficient size to accommodate the current window, then the current window may be placed 266 under previously placed windows and made partially visible. After placing the current window, the updating process may determine 268 if there are remaining windows to update. If there are no 269 windows remaining to update, then updating process may be complete 270. If there are 271 windows remaining to update, then the next window may be selected 260. In some embodiments of the present invention, a user region of interest may be associated with each logical window. Exemplary user regions of interest may comprise the title bar of the window or other portion of the window which may be used to facilitate focus, or activation, of the window to the foreground by a user. In some of these embodiments, when a logical window may be placed under other windows, the placement may be such that the user region of interest may be kept visible.

In some embodiments of the present invention, the window-management module may allocate the central area of the display wall to the logical window with the highest window priority. Subsequent windows may be placed in priority order in an area as close to the central region as possible. In some embodiments of the present invention, the regions may be selected in a clock-wise order as illustrated in an exemplary layout depicted in FIG. 16. A first logical window 282 with highest priority (for example, priority=4) may be placed on a display wall 280 in a substantially central region. A second logical window 284 with next-highest priority (for example, priority=3) may be placed in a location clock-wise-related to the first logical window 282. A third logical window 286 with the next-highest priority (for example, priority=2) may be placed in a location clock-wise-related to the second logical window 284. The third logical window 286 may be placed behind any higher-priority logical windows 284. A fourth logical window 288 may be placed in a location clock-wise-related to the third logical window 286. The fourth logical window 288 may be placed behind any higher-priority logical windows 282.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A system for controlling a composite wall display and an imaging device, said system comprising:
a) a composite wall display comprising a plurality of display panels;
b) an imaging device communicatively coupled to said composite wall display;
c) a virtual wall display process comprising:
i) a script interpreter;
ii) a virtual-wall engine;
iii) a wall-display controller; and
iv) an imaging-device controller; and
d) a virtual canvas associated with said plurality of display panels.

2. A system as described in claim 1 further comprising a first computing system, wherein said first computing system is communicatively coupled with said imaging device and said composite wall display.

3. A system as described in claim 2, wherein said virtual wall display process resides on said first computing system.

4. A system as described in claim 1, wherein said virtual-wall engine manipulates said virtual canvas according to a first command received at said virtual-wall engine from said script interpreter.

5. A system as described in claim 4, wherein said first command is a command effectuating the display of a first image on said composite wall display.

6. A system as described in claim 4, wherein said first command is a command effectuating the printing, on said imaging device, of a first image displayed on said composite wall display.

7. A system as described in claim 4, wherein said first command is a command effectuating the display of an image on said composite wall display, wherein said image is generated at a scanning device associated with said imaging device.

8. A system as described in claim 4, wherein said first command is a command effectuating the copying of a first region of displayed content on said composite wall display to a second region on said composite wall display.

9. A system as described in claim 1, wherein said wall-display controller translates said virtual canvas into commands for operating said composite wall display.

10. A system as described in claim 1, wherein said imaging-device controller translates said virtual canvas into commands for operating said imaging device.

11. A system as described in claim 1, wherein said imaging device is a multi-function peripheral device.

12. A method for window manipulation in a composite wall display, said method comprising:
a) associating a first window priority with a first window of a first size and a first location;
b) monitoring for a first change associated with said first window;
c) monitoring for a first interaction associated with said first window;
d) updating said first window priority based on the results of said monitoring for a first change associated with said first window and said monitoring for a first interaction associated with said first window; and
e) adjusting said first window based on said updated first window priority.

13. A method as described in claim 12, wherein said first change is a change associated with the content of said first window.

14. A method as described in claim 12, wherein said first interaction is an interaction with a user.

15. A method as described in claim 12 further comprising:
a) associating a second window priority with a second window of a second size and a second location;
b) monitoring for a second change associated with said second window;
c) monitoring for a second interaction associated with said second window;
d) updating said second window priority based on the results of said monitoring for a second change associated with said second window and said monitoring for a second interaction associated with said second window; and
e) adjusting said first window based on said updated first window priority and said updated second window priority.

16. A method as described in claim 12, wherein said updating said first window priority comprises adjusting said first window priority in a direction indicative of greater importance when said first change occurs.

17. A method as described in claim 12, wherein said updating said first window priority comprises adjusting said first window priority in a direction indicative of greater importance when said first interaction occurs.

18. A method as described in claim 12, wherein said updating said first window priority comprises adjusting said first window priority in a direction indicative of less importance when said first change and said first interaction do not occur.

19. A method as described in claim 18, wherein said adjusting said first window priority in a direction indicative of less importance comprises adjusting said first window priority based on a life-span measurement associated with said first window.

20. A method as described in claim 12, wherein said composite wall display is communicatively coupled to an imaging device.

21. A method as described in claim 12 further comprising:
a) monitoring for a first attention indicator associated with said first window; and
b) updating said first window priority based on the results of said monitoring for a first change associated with said first window, said monitoring for a first interaction associated with said first window and said monitoring for a first attention indicator associated with said first window.
